(19) United States
(12) Patent Application Publication
(10) Pub. No.: US 2019/0113654 A1
(43) Pub. Date: Apr. 18, 2019

(54) SYSTEM AND APPARATUS FOR SENSING WEATHER CONDITIONS

(71) Applicant: Timothy M. Bush, Englewood, CO (US)

(72) Inventor: Timothy M. Bush, Englewood, CO (US)

(21) Appl. No.: 16/163,092

(22) Filed: Oct. 17, 2018

Related U.S. Application Data
(60) Provisional application No. 62/573,592, filed on Oct. 17, 2017.

(51) Int. Cl. G01W 1/02; G01W 1/11

(52) U.S. Cl. CPC G01W 1/02; G01W 1/11

(57) ABSTRACT

A sensor assembly for gathering microclimate data comprises at least one sensor housing unit, which itself may comprise a plurality of protective structures. The protective structures may be disposed such that air flows between each of the protective structures. At least one sensor may be disposed within the protective structures, the sensor being configured to detect one or more of a temperature, a humidity level, and an atmospheric pressure. The sensor assembly may comprise a plurality of vertical guide posts configured to be affixed to and threaded through the plurality of protective structures and to be attached to an apparatus for affixing the vertical guide posts to the ground.

### CLAIM OF PRIORITY UNDER 35 U.S.C. § 119

The present application for patent claims priority to U.S. Provisional Patent Application No. 62/573,592, entitled “System and Apparatus for Sensing Weather Conditions,” filed Oct. 17, 2017, assigned to the assignee hereof, and expressly incorporated by reference herein.

### FIELD OF THE DISCLOSURE

The technology of the disclosure relates generally to systems and devices for sensing, measuring, and aggregating weather conditions and associated data. Specifically, but without limitation, the disclosure relates to sensor devices that can measure micro-climate conditions and transmit them, and a data aggregation system that can make collected data from the sensor devices useful.

### BACKGROUND

In agriculture, a number of factors determine the quality and nature of produce. Even within one geographical area, or one field in which a particular crop is grown, there can be variations in weather, soil, elevation, and other environmental conditions that affect individual pieces of produce. Such variations are especially notable in certain crops, such as grapes grown for winemaking. In vineyards, even small environmental variations affect the taste of a grape, and in winemaking, where winemakers pay such close attention to the grapes in order to achieve specific flavors and chemical compositions, environmental information is crucial. Currently, winemakers and other types of farmers implement various types of sensor systems to gather environmental data. However, a number of challenges exist to implementing sensors and gathering and using data in certain agricultural applications, such as powering multiple sensors and collecting accurately sensed environmental information in a cost-effective manner. These challenges increase exponentially the more environmental variation exists across a particular crop. Therefore, a need exists for systems and apparatuses that can address these challenges.

### SUMMARY

An aspect of the present disclosure provides a sensor assembly for gathering microclimate data may comprise at least one sensor housing unit, which itself may comprise a plurality of protective structures. The protective structures may be disposed such that air flows between each of the protective structures. At least one sensor may be disposed within the protective structures, the sensor being configured to detect one or more of a temperature, a humidity level, and an atmospheric pressure. The sensor assembly may comprise a plurality of vertical guide posts configured to be affixed to and threaded through the plurality of protective structures and to be attached to an apparatus for affixing the vertical guide posts to the ground.

Another aspect of the disclosure provides a system for sensing and displaying microclimate weather conditions in a field of crops. The system may comprise a plurality of sensor assemblies. Each of the plurality of sensor assemblies may comprise at least one sensor housing unit, the sensor housing unit comprising a plurality of protective structures, the protective structures being disposed in relation to each other such that air flows between each of the plurality of protective structures. The sensor housing units may comprise at least one sensor disposed within the plurality of protective structures, the at least one sensor being configured to detect one or more of a temperature, a humidity level. and an atmospheric pressure. Each of the plurality of sensor assemblies may further comprise a plurality of vertical guide posts, the plurality of vertical guide posts being configured to affix to and thread through the plurality of protective structures and attach to an apparatus for affixing the plurality of vertical guide posts to the ground. The system may further comprise a wireless transceiver, a remote server configured to receive weather sensing data from the at least one sensor assembly and send it to one or more remote computing devices, and an application executed at the one or more remote computing devices, the application configured to display the weather sensing data on a graphical user interface.

### BRIEF DESCRIPTION OF THE DRAWINGS

FIG. 1 shows a sensor assemblies according to the present disclosure.

FIG. 2 shows a two-dimensional temperature profile that may be visualized on a user interface using systems of the present disclosure.

FIG. 3 shows a three-dimensional temperature profile that may be visualized on a user interface using systems of the present disclosure.

FIG. 4 shows a network diagram of sensors, servers, databases, and user interfaces of the present disclosure.

FIG. 5 shows an exemplary sensing unit of the present disclosure

FIG. 6 is a hardware diagram of a computing device that may implement aspects of the present disclosure.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

A system in accordance with the present disclosure may comprise one or more field weather sensor assemblies. An aspect of the field weather sensor assemblies (hereinafter “assembly” or “assemblies” of the present disclosure is that they may comprise a plurality of individual weather sensors for temperature, humidity, air pressure, air quality, light, or other environmental sensors (hereinafter “sensors”), each at different heights along a body of the assembly. In embodiments, an assembly may be several feet tall (e.g., four to seven feet tall), and comprise three or four individual sensors. There are advantages to having multiple weather sensors on a single, tall, field weather sensor assembly for certain crops, such as grape vines and other trees or plants, because such crops can have widely varying temperature and other environmental factor ranges from their roots to their canopies. The multiple weather sensors allow a larger number of accurate data points to be measured along the varying heights of a plant than a single sensor.

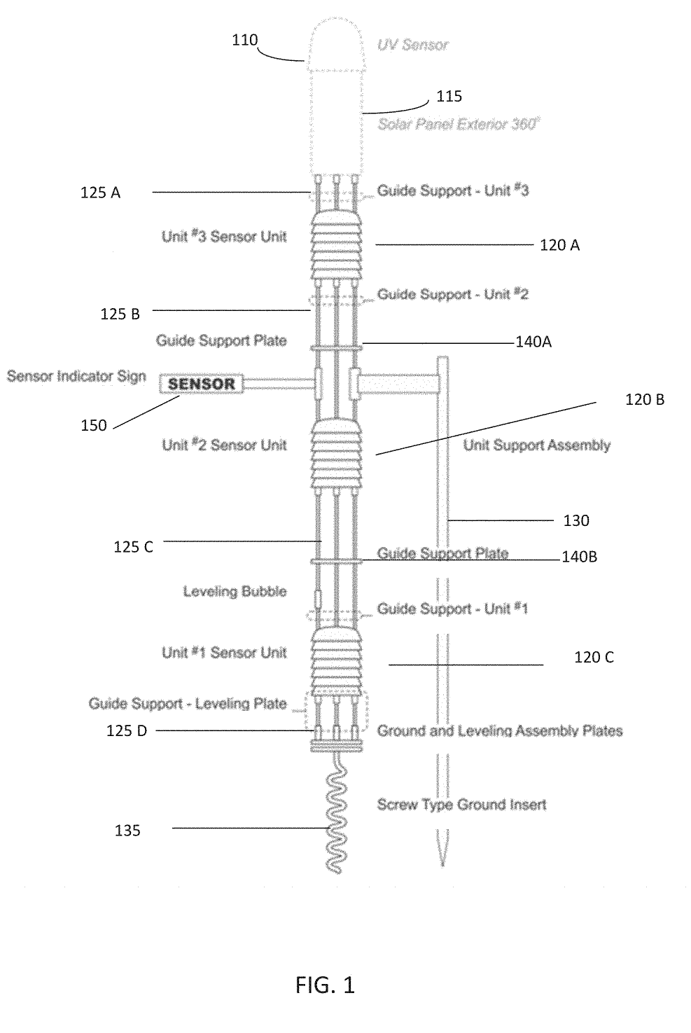

FIG. 1 shows a field weather sensor assembly according to an embodiment of the present disclosure. Other embodiments of the assembly may vary in certain aspects while still falling within the scope of the present disclosure, and the embodiments shown and described in the figures should be construed as exemplary only. As shown, the assembly 100 of FIG. 1 comprises a UV sensor 110, a solar panel 115 on the exterior with a hollow interior for electrical components within 115, sensor housing units 120A-C, guide supports 125A-D, support stake 130, and ground insert 135, which will be described in further detail throughout this disclosure.

Each of the sensor housing units 120A-C may comprise one or more internal temperature and/or other environmental sensors previously described (not shown) and a plurality of protective structures. One or more of the individual sensor housing units 120A-C may also comprise a wireless transceiver for sending and/or receiving sensor data. The assembly 100, and components thereof, may be powered entirely by the solar panel 115 in some embodiments. For example, the solar panel 115 may power the individual weather sensors and the wireless transceiver through electrical wiring within the sensor assembly. In other embodiments, some of the components may be powered by batteries or wired connections to grid power, mains AC power, or a local power generator such as solar panels. The wireless transceiver (not shown) may be implemented by any near-field, short-range or long-range data transmission protocol transmitter and/or receiver, including Bluetooth, RFID, NFC, wireless LAN or WAN, or cellular protocols. The sensor assemblies may further comprise GPS trackers and/or altimeters for geolocation.

Sensor assemblies in accordance with the present disclosure provide a number of advantages over existing sensor equipment in the industry. They may be relatively lightweight, tall enough to cover the height of an entire grape vine (or other plant), and thin enough to be placed close to the trunk, yet strong enough to withstand inclement weather and violent shaking from harvesting equipment. In some embodiments, the entire sensor assembly may weigh less than ten points. In some embodiments, the entire sensor assembly may weigh less than five pounds. In these embodiments, the sensor assembly may still comprise four or more sensor housing units, and be over six feet tall. Additionally, the thin, sturdy assembly may be constructed using low-cost component parts, resulting in a much lower overall cost than traditional weather sensors currently used in agriculture. Many existing weather sensors comprise high-cost, high-sensitivity equipment housed within sturdy exterior materials in order to protect the sensing equipment from damage. These weather sensors can cost thousands of dollars, so typically only one sensor will be used for a wide area of crops, the area sometimes spanning acres. Further, these weather sensors are typically placed proximate to, rather than in, the midst of crops to avoid interference with or damage from farming equipment.

The assemblies of the present disclosure are designed to be low-cost, yet resilient enough so that dozens, hundreds, or even thousands of them may be placed within crops such as vineyards. They are also designed, in many embodiments, to be self-powering and low-maintenance. They may also have low-cost interchangeable parts. As a result, sensor assemblies used with systems of the present disclosure can provide exponentially more data points about microclimates within crops, comprising areas of just a few feet or less, than a single conventional weather station. The present disclosure is also designed to be moveable and portable. Existing sensor equipment in the industry is designed to be stationary, whereas the assembly of the present disclosure can be picked up and moved at the users' discretion to gain additional insight into growing areas and microclimates of particular interest to the user. In sensor assemblies having GPS trackers and/or altimeters, the locations of the assemblies may be used to remotely display where each sensor assembly is, as will be described further in the disclosure.

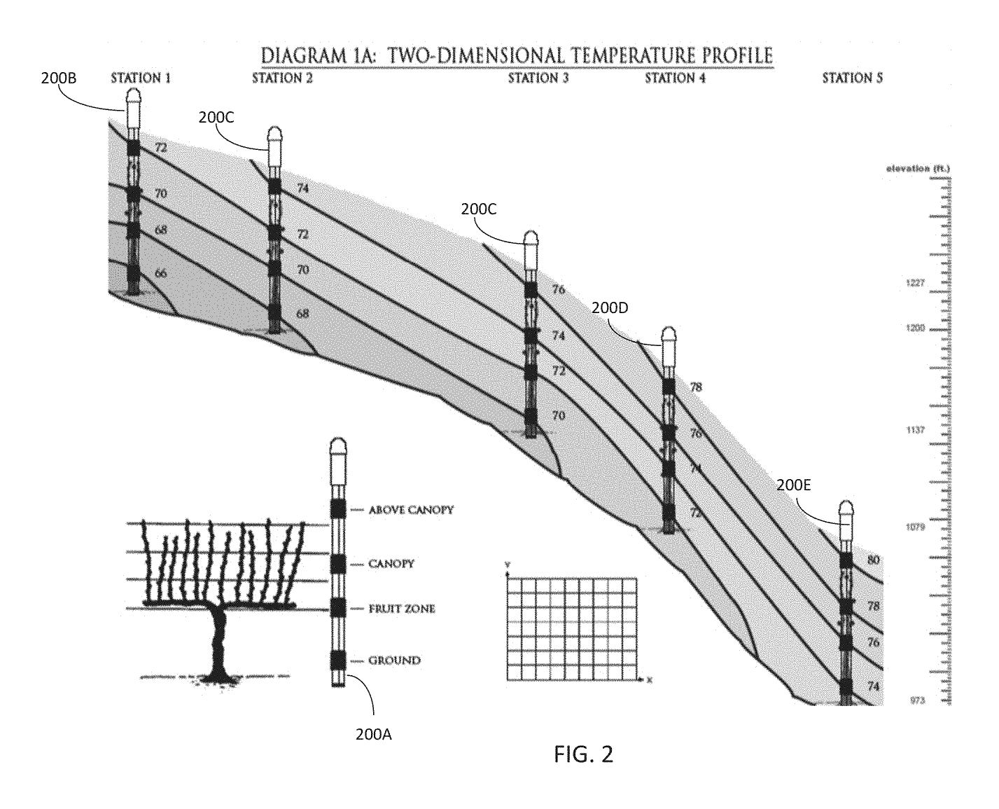

FIG. 2 shows a two-dimensional temperature profile of a section of crops. This temperature profile may be displayed on a graphical user interface on a computing device, which will be described later in the disclosure. An assembly 200A is shown having four sensor housing units. Each housing unit may have one temperature sensor, measuring the temperature at the ground, fruit zone, canopy, and above canopy, respectively, of a single plant. Five assemblies 200B-200E are shown distributed across a field with an elevation change of a few hundred feet, with temperatures associated with each sensor housing unit on each assembly. The GPS trackers on the sensor assemblies may be used to detect the elevation and the location. As shown at station 200E, for example, the lowest sensor housing unit, closest to the ground, shows a temperature of 74 degrees, while each of the higher sensor housing units show temperatures of 76, 78, and 80 degrees, respectively. Such temperature changes in a microclimate are certainly possible due to higher concentrations of humidity and lower levels of sunlight at the bottom of a tree than at the top. For the purposes of the present disclosure, the term “microclimate” may be used to refer to an area immediately proximate to a particular sensor that is closer to that particular sensor than another sensor. At station 200B, however, the overall temperatures are shown as much lower, in the range of 66-72 degrees, which may be due to the increased elevation at the location of station 200B as compared to station 200E. As shown, these five sensor assemblies can provide temperature data points for 20 microclimates. Knowing temperature information to this level of detail may allow farmers to analyze their crop yields in novel ways.

In FIG. 2, the two-dimensional temperature profile graphically depicts representative images of the assemblies 200B-200E at different altitudes, such that those at higher altitudes are depicted higher on the graphical user interface itself. The graphical user interface, as shown, has an elevation graph 210, which corresponds to the actual altitude of each assembly. This method of display allows a user, such as a farmer, to visually process a large amount of temperature and other sensor data, and the relationship of that information to altitude.

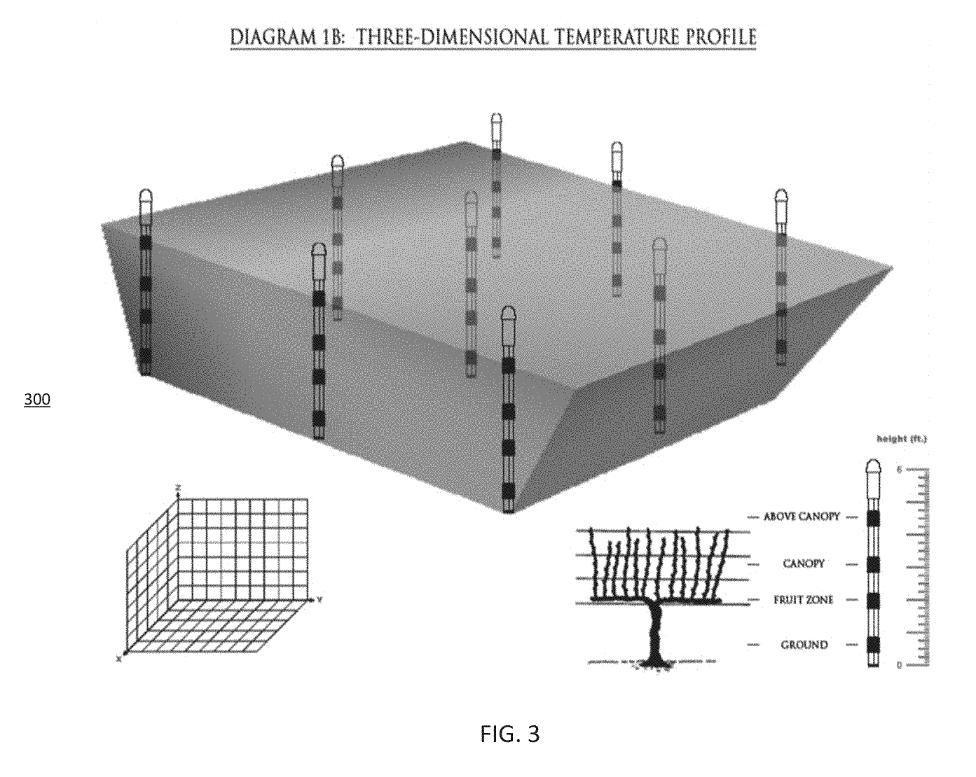

Turning now to FIG. 3, shown is a three-dimensional temperature profile for an exemplary crop section 300 having a plurality of field weather sensor assemblies dispersed within it. The crop section 300 has nine individual assemblies each having four individual temperature sensors, resulting in 36 total microclimate temperature data points. With numerous temperature data points, temperature profiles with various visual indicators may be constructed and displayed on an associated user interface. The display shown in FIG. 3 is one such example of a visual temperature profile. On a color graphical user interface, warmer areas may be displayed in orange, and cooler temperatures displayed in green and blue, for example. This display of weather sensing data may be achieved by associating different colors with different sensed data values and using changes between the different colors to create a visual weather data profile. Such displays can give users easy ways to understand large amounts of data in a visual, easy-to-understand format. It is contemplated that any kind of environmental factor data measured by sensors may be displayed and mapped in similar ways to the display shown in FIG. 3. Other visual displays may be implemented, such as line graphs, bar graphs, pie charts, heat maps, topographical maps, and spreadsheets, to name a few examples.

In FIG. 3, the three-dimensional temperature profile graphically depicts representative images of the assemblies at different altitudes and geographical locations, such that each assembly is depicted in a corresponding representative location on the graphical user interface itself. In embodiments of the display, visual indicators such as graphs and maps may be implemented to show where each assembly is located in the user's field. This method of display allows a user, such as a farmer, to visually process a large amount of temperature and other sensor data, and the relationship of that information to altitude and location within the field.

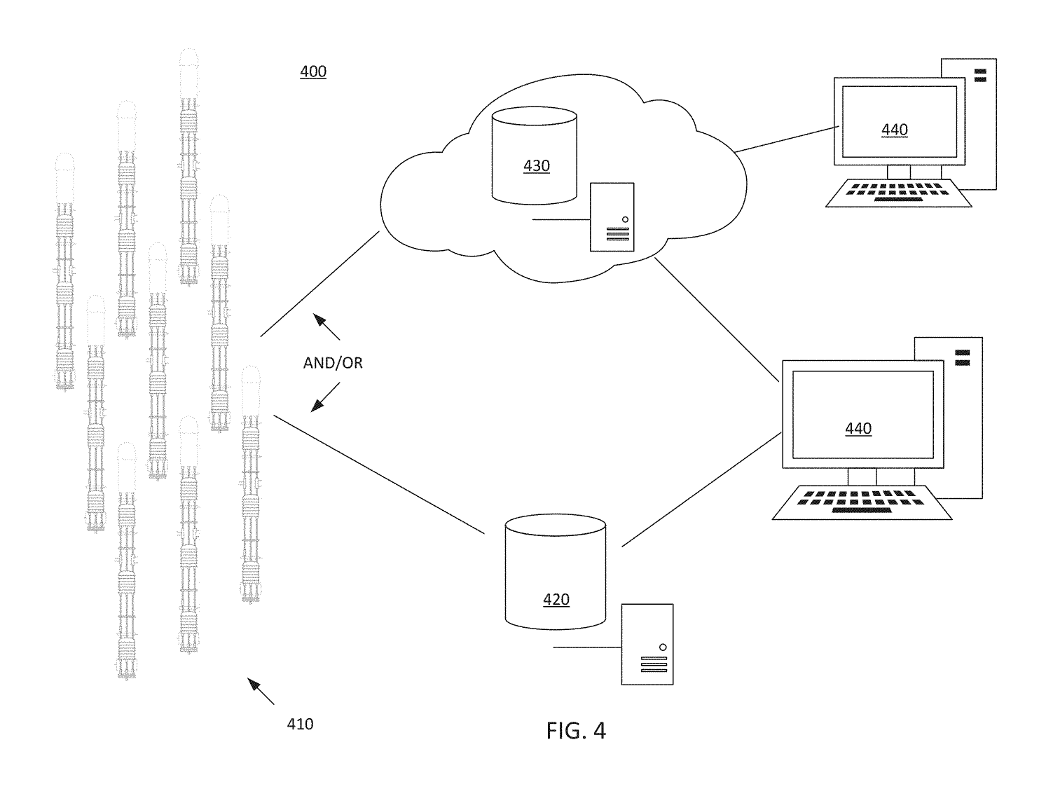

FIG. 4 shows a system 400 for communicating data from a plurality of field weather assemblies to one or more end users of the data on one or more terminals having graphical user interfaces. As shown, a plurality of field weather assemblies 410 may collect weather data about their respective microclimates and wirelessly transmit them to one or more databases and/or servers. The system architecture shown in FIG. 4 is exemplary only, and other embodiments, including those with more sensors, servers, and wireless transmission infrastructure, may be implemented in accordance with the present disclosure. As shown, weather data may be wirelessly transmitted to a local database and server 420, and then be accessed by a remote or local user terminal 440 to graphically display the data. Additionally or alternatively, the data may be transmitted to a remote database and server 430, which may be a cloud server, and then be accessed by a remote or local terminal 450 to display the data. In various embodiments, the data may be accessible to single or multiple users and/or administrators based on permission levels. It is contemplated that software to organize, aggregate, and display the data may be implemented in a cloud server 430 as software as a service (SaaS) or as local and downloadable software. Though not shown, in some systems of the present disclosure, various hubs or gateways may be used to collect and relay data transmissions from a plurality of sensors to the one or more servers. Such hubs or gateways may facilitate the use of lower power or shorter-range transceivers in each individual assembly.

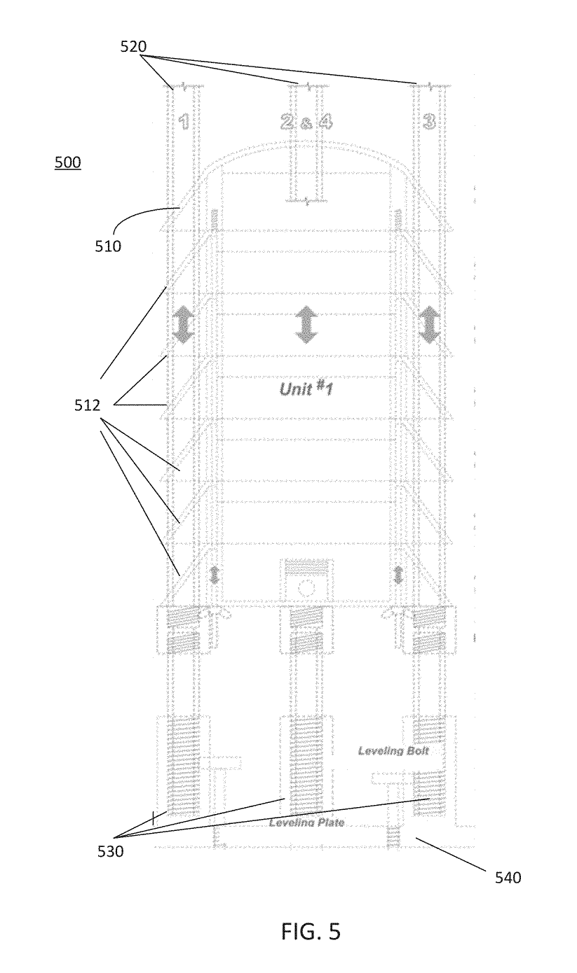

FIG. 5 illustrates an individual sensor housing unit 500 of a field weather sensor assembly in accordance with the present disclosure. Each assembly may comprise one or more of these individual sensor housing units, depending on the data requirements of particular crops. For crops for which only one data point is necessary, the assembly may only have a single housing unit, but in others, such as those implemented in grape vineyards, the assemblies may comprise three or four, or even more sensor housing units. The sensor housing unit 500 may comprise a plurality of protective structures. These may include a top protective structure 510, to which an individual sensor or a plurality of sensors may be hung or otherwise attached. The top protective structure may be rounded on top to protect the internal sensor(s) from precipitation. The surrounding protective structures 512 may be shaped like a frustum of a cone and spaced apart from each other to allow sufficient air flow to enable sensing by the internal sensor(s). Each of the protective structures 510 and 512 may be fabricated from a plastic, polymer, or other suitable material that is lightweight, durable, protective, and not subject to extreme changes in temperature due to sun exposure.

The protective structures 510 and 512 may be arranged in a vertical fashion, spaced apart, through the use of vertical guide supports 520. These vertical guide supports 520 may run through holes within the protective structures 510 and 512. The arrangement of the vertical guide supports 520 and the protective structures 510, 512 may facilitate the air flow between the structures and also provide a structure that can sway or shake back and forth without breaking. The vertical guide supports 520 may be made of metal, plastic, polymer, or composite material that is suitably strong, flexible, and lightweight. The vertical guide supports 520 may connect to additional sensor housing units. The sensor housing unit 500 may further comprise leveling bolts 530 that affix the housing unit to a leveling plate 540. These leveling bolts 530 and/or leveling plate 540 may be used to affix the sensor housing unit to a bottom ground screw insert.

Turning back to FIG. 1, the screw type ground insert 135 may be used to securely plant the assembly 100 into the ground. As shown, the vertical guide supports 125A-C may run the length of the assembly 100 and be used to attach other structural and functional components. For example, guide support plates 140A and 140B may add structural support in between the individual sensor housing units 120A-C. They may also be used to attach to one or more unit support assemblies 130, which may provide an extra footing into the ground to help the assembly 100 withstand shaking. Additionally, a sensor sign 150 may be attached to the vertical guide supports 125A-C so users may easily see the location of the assembly 100. Such signs may be especially useful in crops wherein the leaves of the plant would obscure the sensor assembly if it were situated close to a trunk. Additional or different components may be affixed to the vertical guide supports or to other parts of the assembly. As shown, the solar panel exterior 115 is a cylindrical, thin, flexible solar panel, but in other embodiments, flat, rigid, and/or rectangular solar panels may be used. Various shapes of UV sensors may be utilized as well.

Embodiments of the present disclosure allow the implementation of numerous weather data collection points at a microclimate level. As shown and described herein, the construction and design of these assemblies allows for low-cost implementation of sturdy and reliable sensors. The large number of data points that are able to be collected allow for data aggregation, modeling, and display that provides numerous benefits to crop growers.

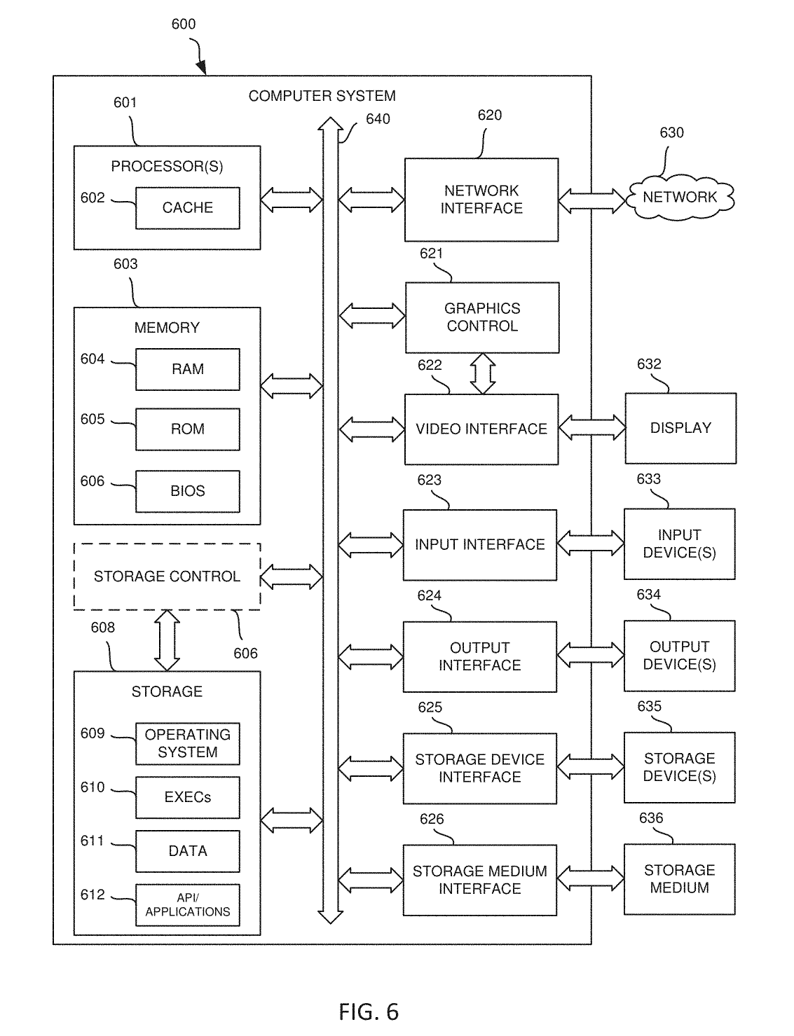

Referring next to FIG. 6, it is a block diagram depicting an exemplary machine that includes a computer system 600 within which a set of instructions can execute for causing a device to perform or execute any one or more of the aspects and/or methodologies for transmitting and displaying weather information of the present disclosure. The components in FIG. 6 are examples only and do not limit the scope of use or functionality of any hardware, software, embedded logic component, or a combination of two or more such components implementing particular embodiments.

Computer system 600 may include a processor 601, a memory 603, and a storage 608 that communicate with each other, and with other components, via a bus 640. The bus 640 may also link a display 632, one or more input devices 633 (which may, for example, include a keypad, a keyboard, a mouse, a stylus, etc.), one or more output devices 634, one or more storage devices 635, and various tangible storage media 636. All of these elements may interface directly or via one or more interfaces or adaptors to the bus 640. For instance, the various tangible storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 601 (or central processing unit(s) (CPU(s))) optionally contains a cache memory unit 602 for temporary local storage of instructions, data, or computer addresses. Processor(s) 601 are configured to assist in execution of computer readable instructions. Computer system 600 may provide functionality for the components depicted in FIG. 1 as a result of the processor(s) 601 executing non-transitory, processor-executable instructions embodied in one or more tangible computer-readable storage media, such as memory 603, storage 608, storage devices 635, and/or storage medium 636. The computer-readable media may store software that implements particular embodiments, and processor(s) 601 may execute the software. Memory 603 may read the software from one or more other computer-readable media (such as mass storage device(s) 635, 636) or from one or more other sources through a suitable interface, such as network interface 620. The software may cause processor(s) 601 to carry out one or more processes or one or more steps of one or more processes described or illustrated herein. Carrying out such processes or steps may include defining data structures stored in memory 603 and modifying the data structures as directed by the software.

The memory 603 may include various components (e.g., machine readable media) including, but not limited to, a random-access memory component (e.g., RAM 604) (e.g., a static RAM “SRAM,” a dynamic RAM “DRAM,” etc.), a read-only component (e.g., ROM 605), and any combinations thereof. ROM 605 may act to communicate data and instructions unidirectionally to processor(s) 601, and RAM 604 may act to communicate data and instructions bidirectionally with processor(s) 601. ROM 605 and RAM 604 may include any suitable tangible computer-readable media described below. In one example, a basic input/output system 606 (BIOS), including basic routines that help to transfer information between elements within computer system 600, such as during start-up, may be stored in the memory 603.

Fixed storage 608 is connected bidirectionally to processor(s) 601, optionally through storage control unit 607. Fixed storage 608 provides additional data storage capacity and may also include any suitable tangible computer-readable media described herein. Storage 608 may be used to store operating system 609, EXECs 610 (executables), data 611, API applications 612 (application programs), and the like. Often, although not always, storage 608 is a secondary storage medium (such as a hard disk) that is slower than primary storage (e.g., memory 603). Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide nonvolatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, specifically mobile devices and enterprise systems, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 630, may employ a wired and/or a wireless mode of communication. In general, any network topology may be used.

Information and data can be displayed through a display 632. Examples of a display 632 include, but are not limited to, a liquid crystal display (LCD), an organic liquid crystal display (OLED), a cathode ray tube (CRT), a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621.

In addition to a display 632, computer system 600 may include one or more other peripheral output devices 634 including, but not limited to, an audio speaker, a printer, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A sensor assembly for gathering microclimate data, the sensor assembly comprising:
at least one sensor housing unit, the sensor housing unit comprising a plurality of protective structures, the protective structures being disposed in relation to each other such that air flows between each of the plurality of protective structures
at least one sensor disposed within the plurality of protective structures, the at least one sensor being configured to detect one or more of:
a temperature;
a humidity level; and
an atmospheric pressure
a plurality of vertical guide posts, the plurality of vertical guide posts being configured to:
affixed to and threaded through the plurality of protective structures; and
attach to an apparatus for affixing the plurality of vertical guide posts to the ground.

2. The sensor assembly of claim 1, further comprising:
one or more additional sensor housing units, the one or more additional sensor housing units being disposed directly above the at least one sensor housing unit and affixed to the plurality of vertical guide posts.

3. The sensor assembly of claim 1, further comprising:
a wireless transceiver in communication with the at least one sensor configured to send information gathered by the sensor to a remote computing device.

4. The sensor assembly of claim 1, wherein the apparatus for affixing the plurality of vertical guide posts to the ground comprises one or more leveling bolts and a leveling plate.

5. The sensor assembly of claim 1, further comprising a solar panel configured to power one or more components of the sensor assembly.

6. The sensor assembly of claim 5, further comprising a wireless transceiver, and wherein the solar panel is the sole source of power for any component of the sensor assembly.

7. The sensor assembly of claim 1, wherein the solar panel comprises a thin, flexible sheet.

8. The sensor assembly of claim 1, further comprising a UV sensor, the UV sensor being disposed above a topmost sensor housing apparatus.

9. The sensor assembly of claim 1, wherein the sensor assembly weighs less than ten pounds.

10. The sensor assembly of claim 9, wherein the sensor assembly is at least six feet tall.

11. A system for sensing and displaying microclimate weather conditions in a field of crops, the system comprising:
a plurality of sensor assemblies, each of the plurality of sensor assemblies comprising:
at least one sensor housing unit, the sensor housing unit comprising a plurality of protective structures, the protective structures being disposed in relation to each other such that air flows between each of the plurality of protective structures;
at least one sensor disposed within the plurality of protective structures, the at least one sensor being configured to detect one or more of:
a temperature;
a humidity level; and
an atmospheric pressure
a plurality of vertical guide posts, the plurality of vertical guide posts being configured to:
affix to and thread through the plurality of protective structures; and
attach to an apparatus for affixing the plurality of vertical guide posts to the ground; and
a wireless transceiver;
a remote server configured to receive weather sensing data from the at least one sensor assembly and send it to one or more remote computing devices; and
an application executed at the one or more remote computing devices, the application configured to display the weather sensing data on a graphical user interface.

12. The system of claim 11, wherein the system comprises a plurality of sensor assemblies, each of the plurality of sensor assemblies having a plurality of sensor housing units, and wherein the display of weather sensing data comprises showing representative images of the plurality of sensor assemblies at different heights on the graphical user interface.

13. The system of claim 12, wherein the graphical user interface further shows the representative images if the plurality of sensor assemblies in different locations on the graphical interface, the different locations corresponding to actual locations of the plurality of sensor assemblies.

14. The system of claim 11, wherein each of the display of weather sensing data comprises associating different colors with different sensed data values and using changes between the different colors to create a visual weather data profile.

15. The system of claim 11, wherein at least some of the plurality of sensor assemblies comprises a UV sensor.

16. The system of claim 11, wherein at least some of the plurality of sensor assemblies comprises four sensor housing units stacked vertically.

17. The system of claim 11, wherein at least some of the plurality of sensor assemblies comprise a solar panel.

18. The system of claim 11, wherein each of the plurality of sensor assemblies comprises a sensor sign, the sensor sign configured such that it is visible beyond branches of a crop when a main body of the sensor assembly is obscured by the branches.

19. The system of claim 11, wherein each of the plurality of sensor assemblies comprises an altimeter.

20. The system of claim 11, wherein each of the plurality of sensor assemblies comprises a GPS tracker.
